(19) United States
(12) Patent Application Publication
(10) Pub. No.: US 2005/0029859 A1
(43) Pub. Date: Feb. 10, 2005

(54) Fluid-pressure brake system for a vehicle

(76) Inventors: Uwe Bensch, Hannover (DE); Bernd Kiel, Wunstorf (DE); Hartmut Rosendahl, Hannover (DE); Henning Forster, Nordstemmen (DE); Wilfried Menze, Springe (DE); Otmar Struwe, Hannover (DE)

Correspondence Address: Kramer Levin Naftalis & Frankel LLP, 919 Third Avenue, New York, NY, 10022, US

(21) Appl. No.: 10/900,658

(22) Filed: Jul. 28, 2004

(30) Foreign Application Priority Data
Aug. 8, 2003 (DE) 103 36 611.3

(51) Int. Cl. B60T 13/66

(52) U.S. Cl. 303/89; 303/20

(57) ABSTRACT

A fluid-pressure brake system for a vehicle having a parking brake function in which, in response to actuation of an electrical parking brake signal transmitter, and without actuation of a brake pedal, at least one wheel brake of the brake system is actuated via an actuator to which the fluid is admitted. A parking brake module is provided in which there is integrated an electronic control unit as well as valve devices that are electrically actuatable by the electronic control unit. The electronic control unit actuates the parking brake function upon receiving from the parking brake signal transmitter an electrical actuating signal demanding actuation of the parking brake function and, as part of the parking brake function, the electronic control unit controls the admission of fluid to the actuator by means of the electrically actuatable valve devices.

### BACKGROUND OF THE INVENTION

The present invention relates to a fluid-pressure brake system for a vehicle.

DE 198 57 393 A1 describes a conventional vehicle air-brake system provided with a parking brake device. The system described in DE 198 57 393 functions without pneumatic lines to a parking brake actuating element used for actuation of the parking brake device by the vehicle driver. Typically, the parking brake actuating element is designed as a pneumatic valve that can be manually operated. In the parking brake device described in DE 198 57 393 A1, signals for actuation of the parking brake are transmitted electrically, thus obviating the need for installation of pneumatic lines in the driver's cab.

The parking brake function described in DE 198 57 393 A1 is achieved by providing a plurality of conventional solenoid valves via which the brake cylinders or the spring actuators of the vehicle's brake system can be acted on by compressed air. Such an arrangement of additional valves in an air-brake system of a vehicle leads to increased manufacturing and assembly complexity during installation of the brake system in the vehicle as well as to higher costs. Furthermore, such additional components, connected by pneumatic lines, increase the risk of failure of the brake system.

Accordingly, it is desired to provide, for a vehicle, a fluid-pressure brake system in which there can be integrated, with little complexity and in compliance with applicable safety regulations for brake systems, a parking brake function that can be actuated via an electrical signal transmitter.

### SUMMARY OF THE INVENTION

Generally speaking, in accordance with the present invention, a new fluid-pressure vehicle brake system is provided which improves over prior art systems.

According to the present invention, a single component, specifically a parking brake module actuatable via an electrical signal transmitter, is responsible for the vehicle parking brake function. Advantageously, the necessary valves for control of fluid flows are already integrated in the parking brake module according to the present invention in the form of an electrically actuatable valve device as well as an electronic control unit for actuation of the valve device. Accordingly, the parking brake function can be integrated very simply, especially into conventional air-brake systems. Indeed, the system according to the present invention avoids the complexity and concomitant cost associated with conventional air-brake systems having a purely pneumatic parking brake function while satisfying applicable safety regulations.

A further advantage of the present invention is that the parking brake module can be integrated in simple manner not only into electrically controlled brake systems (EBSs) but also, in equally simple manner, into conventional air-brake systems with or without anti-lock brake systems (ABSs).

According to another advantageous embodiment of the present invention, the electrically actuatable valve device is provided with a bistable valve having a bistable switching function with two operating states. In the first operating state, a fluid can be fed to the actuator that operates the wheel brake. In the second operating state, fluid can be removed from the actuator. The use of such a bistable valve has the advantage that, in the event of failure or malfunction of the on-board voltage supply, the valve remains in its last established operating state. Unlike conventional systems employing valves having a set normal operating position in the event of electrical power failure, the use of the bistable valve according to the present invention has the advantage that it enables compliance with legal requirements according to which the parking brake must remain in its last established condition in the event of failure or malfunction of the on-board voltage supply.

According to a further advantageous embodiment of the present invention there is provided, on or in the parking brake module, an electrical energy accumulator, which is used to maintain the parking brake function at least partly in the event of failure or malfunction of the on-board voltage supply. As will be described in greater detail hereinafter, this has the advantage that certain aspects of the parking brake function can still be activated even in the event of failure or malfunction of the on-board voltage supply.

Still other objects and advantages of the invention will in part be obvious and will in part be apparent from the specification.

The invention accordingly comprises the features of construction, combination of elements, and arrangement of parts which will be exemplified in the constructions hereinafter set forth, and the scope of the invention will be indicated in the claims.

### BRIEF DESCRIPTION OF THE DRAWINGS

For a fuller understanding of the invention, reference is had to the following description taken in connection with the accompanying drawings in which:

FIG. 1 is a schematic diagram of an air-brake system in accordance with one embodiment of the present invention;

FIG. 2 depicts a parking brake module provided in the embodiment of the inventive air-brake system depicted in FIG. 1;

FIG. 3 depicts a parking brake signal transmitter provided in the embodiment of the inventive air-brake system depicted in FIG. 1;

FIGS. 4, 5 depict an embodiment of the parking brake signal transmitter as a proportional brake-signal transmitter in accordance with another embodiment of the present invention;

FIGS. 6a-6c are graphical depictions of signal characteristics of the proportional brake-signal transmitter according to the present invention;

FIG. 7 is a schematic diagram of an air-brake system according to another embodiment of the present invention;

FIG. 8 depicts a further embodiment of the parking brake module in accordance with the present invention; and

FIG. 9 depicts a further embodiment of a bistable valve in accordance with the present invention.

### DETAILED DESCRIPTION OF THE PREFERRED EMBODIMENTS

The present invention will be explained hereinafter in the context of an electrically controlled brake system. It should be appreciated, however, that the present invention has application with respect to brake systems that are not electrically controlled.

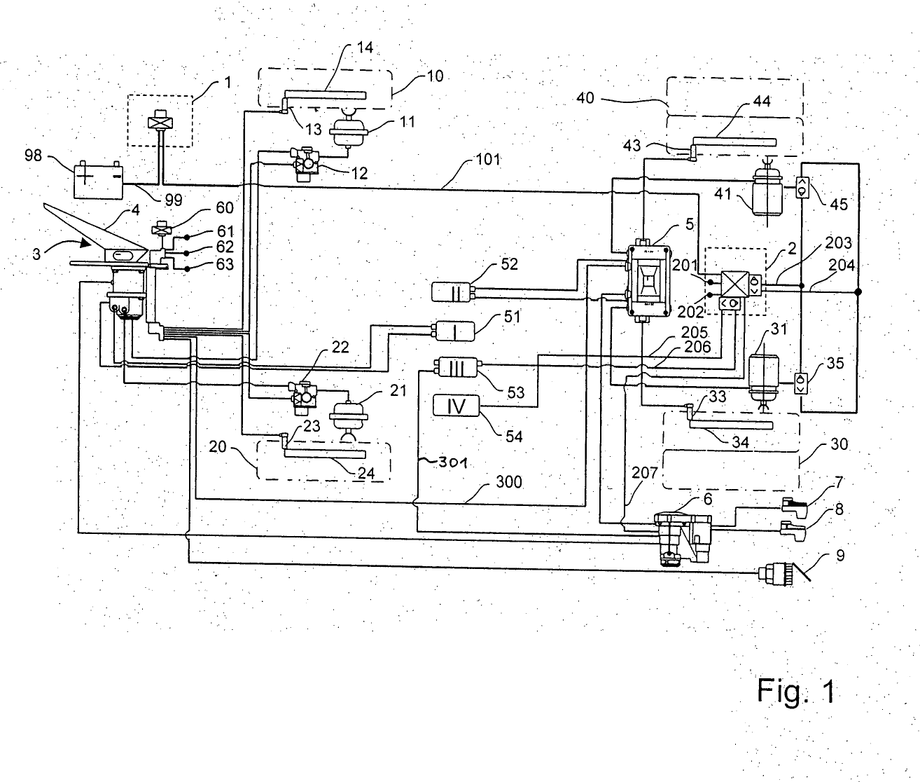

Referring now to the drawing figures, where like and corresponding parts are denoted by like reference numerals, FIG. 1 is a schematic diagram depicting an air-brake system for a four-wheel vehicle. The vehicle brake system depicted in FIG. 1 is of the electrically controlled type. That is, the injection of brake pressure to the individual wheel brakes is controlled by electrical/electronic control elements.

The vehicle depicted to FIG. 1 has four wheels 10, 20, 30, 40, each equipped with a wheel brake to permit individual braking. Wheels 10, 20, also referred to hereinafter as “front wheels,” are allocated to the front axle of the vehicle. Wheels 30, 40, also referred to hereinafter as “rear wheels,” are allocated to the rear axle of the vehicle. To simplify FIG. 1, only the respective air-brake cylinders 11, 21, 31, 41 of the wheel brakes are depicted.

Electromagnetically actuatable valves for influencing the brake pressure are connected on the inlet sides of air-brake cylinders 11, 21, 31, 41, respectively. In the case of front wheels 10, 20, valves 12, 22 are used for this purpose. For rear wheels 30, 40, the respective valves are integrated into one rear-axle brake-control module 5.

Also disposed on wheels 10, 20, 30, 40, respectively, are speed sensors which permit determination of the speed of rotation of the respective wheel. Each speed sensor comprises a pole wheel 14, 24, 34, 44, which is attached to the respective wheel 10, 20, 30, 40 such that it rotates therewith, and which is coupled electromagnetically to an inductive wheel sensor 13, 23, 33, 43.

Wheel sensors 13, 23 as well as valves 12, 22 of front wheels 10, 20 are electrically connected to a front-axle brake-control module 3. Valves 12, 22 are also in communication with front-axle brake-control module 3 via compressed-air lines. Front-axle brake-control module 3 is used to control the wheel brakes of front wheels 10, 20, or, more specifically, for injecting brake pressure for brake cylinders 11, 21 in response to brake actuation by the vehicle driver, as well as in response to further vehicle conditions, such as, for example, brake slip or brake-lining wear. In order to supply the compressed air needed for this purpose, front-axle brake-control module 3 is in communication with a first compressed-air reservoir 51 via pneumatic lines, which for safety reasons are preferably dual lines.

Front-axle brake-control module 3 is also provided with a brake-signal transmitter to measure the braking intent of the vehicle driver. The brake-signal transmitter comprises an electrical sensor, which measures any mechanical actuation of the brake pedal 4 and delivers a signal representative of this actuation to an electronic control unit disposed in front-axle brake-control module 3. By evaluating these received signals and taking into consideration other variables derived, for example, from the signals of wheel sensors 13, 23, 33, 43, such as the danger of wheel lock, wear of the brake linings and braking-force distribution as a function of axle load, the electronic control unit determines the brake pressure to be established in brake cylinders 11, 21 and thus achieves adjustment of the brake pressure by actuation of valves 12, 22.

In addition, front-axle brake-control module 3 is equipped with a manual control element in the form of a hill-brake signal transmitter 60, and with a power-supply port 61, a data-interface port 62 and a service port 63.

The rear-axle brake-control module 5 is similar to that of front-axle brake-control module 3, except that it does not include a brake-signal transmitter and brake pedal. Rear-axle brake-control module 5 is in communication with a second compressed-air reservoir 52 via pneumatic lines, which for safety reasons are preferably dual lines. Rear-axle brake-control module 5 is also provided with a data interface which is electrically connected (via an electric line 300) to the data interface of front-axle brake-control module 3.

Modules 3, 5 exchange data via data interfaces. For example, from front-axle brake-control module 3, rear-axle brake-control module 5 receives the driver's braking command, which is measured from actuation of the brake pedal 4 by means of the brake-signal transmitter, and injects brake pressure into brake cylinders 31, 41 of rear wheels 30, 40 via valves disposed in rear-axle brake-control module 5 in accordance with predetermined algorithms. Rear-axle brake-control module 5 obtains the compressed air necessary for this purpose from second compressed-air reservoir 52.

Brake cylinders 31, 41 are designed as combinations of spring actuators with diaphragm cylinders. This means that brake cylinders 31, 41 function not only as diaphragm cylinders, as is the case for brake cylinders 11, 21, for example, but additionally as spring actuators. Brake cylinders 31, 41 each contain a diaphragm part in pneumatic communication with the service-brake system of the rear axle and which can be acted on by the actual brake pressure, as well as a spring-actuator part, which is preferably pneumatically isolated from the diaphragm part and can be acted on by compressed air via separate pneumatic lines.

The spring-actuator part can be allocated to the parking brake system of the vehicle. The spring-actuator part includes a spring-actuator function which compresses an accumulator spring when the spring-actuator part is acted on by compressed air and thus reduces the braking effect. The accumulator spring relaxes when the spring-actuator part is vented and thus exerts a braking effect due to the spring-actuator function on the brake associated with the relevant brake cylinder. Brake cylinders of this type will be referred to hereinafter as “spring-actuated brake cylinders.”

Spring-actuated brake cylinders permit a parking brake function capable of braking or immobilizing the vehicle even in the absence of compressed air. This parking brake function becomes active when the spring-actuator parts of brake cylinders 31, 41 are vented to below a minimum pressure value. For separate actuation of the parking brake function in a manner independent of actuation of brake pedal 4, the compressed-air port of the spring-actuator part in conventional air-brake systems is in communication with a pneumatic manual brake valve.

In contrast to the foregoing, in accordance with an embodiment of the present invention, a parking brake module 2 is connected to the compressed-air ports of the spring-actuator parts of brake cylinders 31, 41 via shuttle valves 35, 45 and pneumatic lines 203, 204, which for safety reasons are preferably dual lines. Module 2 permits pressure control at these compressed-air ports by means of electronic control devices. In the event of a leak in one of pneumatic lines 203, 204, compressed-air control can be maintained via the other pneumatic line. This is achieved by the combination of shuttle valves 35, 45 and of a further shuttle valve disposed on the outlet side of parking brake module 2 with pneumatic lines 203, 204. For this purpose, the shuttle valves automatically shut off the pneumatic line 203, 204 having the lower pressure.

The arrangement of dual pneumatic lines is also known as a pipe-break safeguard. The pipe-brake safeguard is used mainly in mass passenger transportation vehicles, such as, for example, buses, in order to meet strict safety requirements and corresponding legal regulations. It should be understood that the pipe-break safeguard represents an optimal expansion of parking brake module 2, but may not be required, depending on need and applicable legal regulations.

Parking brake module 2 is connected via multi-conductor electric line 101 to a manual operating element in the form of parking brake signal transmitter 1. Via a multi-conductor electric line 99, parking brake signal-transmitter 1 is supplied with electrical energy by a power-supply unit 98, such as a vehicle battery.

Further, for the supply of compressed air, parking brake module 2 is in communication via a pneumatic line 206 with a third compressed-air reservoir 53, and via a pneumatic line 205 with a fourth compressed-air reservoir 54. The use of two separate pneumatic lines 205, 206 for the compressed-air supply of parking brake module 2 is also for safety reasons.

Parking brake module 2 is provided with ports 201, 202 for the voltage supply and the data interface. Port 201 for the data interface is used for connection to a vehicle data-bus system, also known as the “vehicle bus.” The vehicle bus is used for data exchange between different devices, such as modules 3, 5, provided in the vehicle and containing an electronic controller. For this purpose, modules 3, 5 are connected to the vehicle bus via respective data-interface ports.

The vehicle discussed above is also suited for coupling to a trailer vehicle. In this context, the vehicle described above is the “tractor” vehicle, while the combination of tractor vehicle and trailer vehicle is referred to as a “vehicle train.”

The brake system depicted in FIG. 1 also contains a trailer control valve 6, which is used for brake-pressure control of a coupled trailer vehicle. For the compressed-air supply, trailer control valve 6 is in communication via a pneumatic line 301 with third compressed-air reservoir 53. Via compressed-air ports 7, 8, trailer control valve 6 delivers compressed air drawn from compressed-air reservoir 53 to the brake system of a coupled trailer vehicle in a graduated manner dictated by electrical and pneumatic control signals.

To control pressure delivery, trailer control valve 6 is provided with an electrical signal input which is connected to front-axle brake-control module 3 and by which trailer-control valve 6 receives an electrical signal, such as a pulse-width-modulated signal, which represents the driver's braking command. Alternatively, the electrical signal input can also be connected to rear-axle brake-control module 5.

In addition to the electrical signal input, there are provided first and second pressure-control inlets for receiving pneumatic control signals. The first pressure-control inlet is connected to a trailer control outlet of a pneumatic pressure-control loop of front-axle brake-control module 3, which loop is provided as a redundancy. The second pressure-control inlet is in communication with parking brake module 2 via a pneumatic line 207.

An electrical plug connection 9 is provided for the power supply and for transmission of data signals for the trailer vehicle.

Compressed-air reservoirs 51, 52, 53, 54 can be filled with compressed air via a compressed-air supply system (not shown in the drawings), such as a compressor driven by the vehicle's engine.

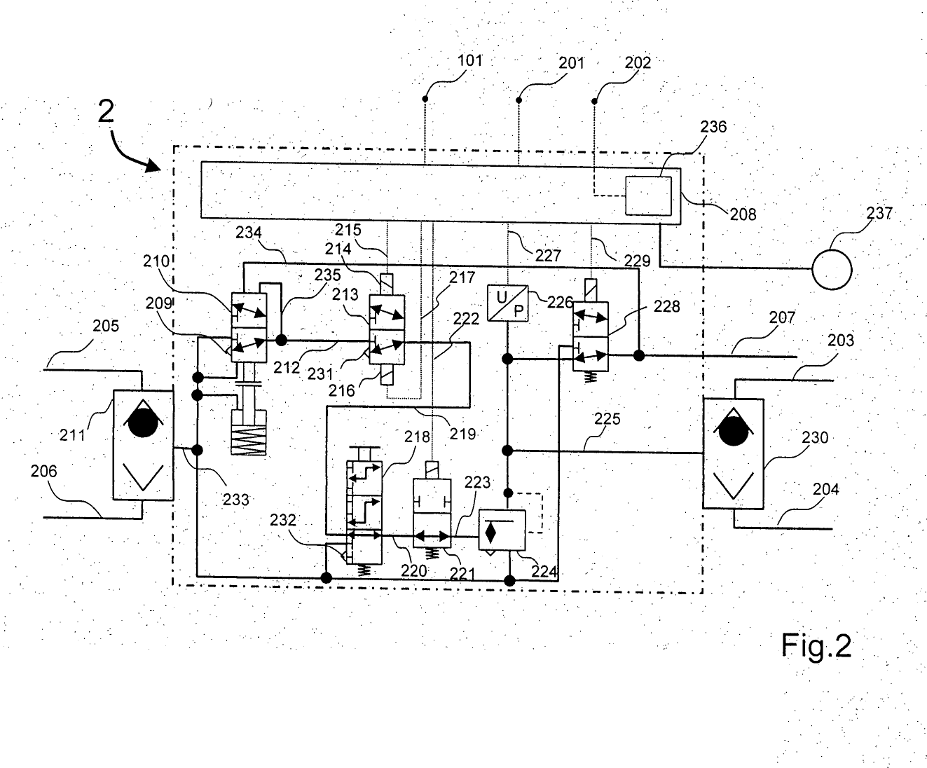

Referring now to FIG. 2, in which parking brake module 2 according to an embodiment of the present invention is depicted in detail, parking brake module 2 is supplied with compressed air from compressed-air reservoirs 53, 54 via pneumatic lines 205, 206. Pneumatic lines 205, 206 open into a shuttle valve 211, the outlet of which is in communication via a compressed-air supply line 233 with a stabilizing valve 210, among other components. It should be understood that stabilizing valve 210 represents an optimal expansion of parking brake module 2, but may not be required, depending on need and applicable legal regulations.

Stabilizing valve 210 is used to prevent undesired rolling of the vehicle, as could occur if the vehicle is parked in gear without engagement of the parking brake function. In this case, by virtue of the drive train, the engaged gear is usually sufficient on its own to prevent the vehicle from rolling. However, depending on how long the vehicle has not been in use, it is possible that, due to loss of compressed air from the pneumatic system, the parking brake function is automatically activated because of the spring-actuator function of brake cylinders 31, 41, even though the driver, for example, has not intentionally caused such actuation of the parking brake function. When the vehicle engine is subsequently started, which is usually done without any gear engaged, it can happen under such circumstances that, because the compressed-air reservoirs 51, 52, 53, 54 become filled with compressed air by the compressed-air supply system, the reservoir pressure in the pneumatic system becomes sufficient to cause cancellation of the spring-actuator function in brake cylinders 31, 41. In such case, the vehicle would become completely unbraked without suitable countermeasures, and could begin to move if the roadway inclination is sufficiently steep. Such rolling of the vehicle can be dangerous and is therefore undesired. Undesired rolling of the vehicle is prevented by stabilizing valve 210, as will be explained in greater detail hereinafter in connection with the further components depicted in FIG. 2.

Via a pneumatic line 212, stabilizing valve 210 is in communication on its outlet side with a bistable valve 213. In the embodiment depicted in FIG. 2, stabilizing valve 210 is a pneumatically actuatable 3/2-way valve. Via a pneumatic line 235, it is acted on by its outlet-side pressure and, via a pneumatic line 234, it is acted on by the pressure delivered via pneumatic line 207 to trailer control valve 6.

In a first switched position illustrated in FIG. 2, the stabilizing valve places pneumatic line 212 in communication with a vent port 209 in communication with atmosphere. This position, which is also referred to as a “safety position,” is occupied under the effect of spring force when the pressure in pneumatic lines 234, 235 drops below a minimum value. In the safety position, stabilizing valve 210 brings about venting of brake cylinders 31, 41 and thus actuation of the spring-actuator function.

In a second switched position, which is also referred to as a “working position,” stabilizing valve 210 places compressed-air supply line 233 of the inlet side in communication with pneumatic line 212 of the outlet side.

Bistable valve 213 connected to pneumatic line 212 is designed as an electromagnetically actuatable 3/2-way valve. As illustrated in FIG. 2, it is provided with a first switched position, referred to hereinafter as the “venting position,” in which a port on the outlet side in communication with a pneumatic line 219 is in communication with a vent port 231 in communication with atmosphere. In a second switched position, referred to hereinafter as “compressed-air supply position,” bistable valve 213 places pneumatic line 212 in communication with pneumatic line 219.

The basic design of bistable valves is known from WO 00/23740 A1, for example. However, unlike conventional solenoid valves that are equipped with a restoring spring and that are urged to a preselected switched position by the force of the restoring spring when the electromagnet is not energized (that is, when electrical voltage is not present), bistable valve 213 according to the present invention does not have a preselected switched position in deenergized condition.

In the embodiment of bistable valve 213 depicted in FIG. 2, there is provided a first electromagnet 214 which, when actuated, can move bistable valve 213 to its second switched position. There is also provided a second electromagnet 216, by which bistable valve 213 can be moved to its first switched position. To avoid undefined states, electromagnets 214, 216 are not actuated simultaneously.

Electromagnets 214, 216 are connected via electric lines 215, 217 to an electronic control unit 208. In a further embodiment, the bistable valve is provided with only one electromagnet for actuation. In this case, changeover between the two switched positions then takes place by the fact that electronic control unit 208 reverses the polarity of the electrical voltage at the electromagnet.

On the outlet side of bistable valve 213 there is connected a manually actuatable 4/3-way valve 218, referred to hereinafter as a “manual actuating valve.” Manual actuating valve 218 can be moved into one of three switched positions by manual actuation of a handle.

In the first switched position, the pressure in compressed-air supply line 233 is allowed to pass through to a pneumatic line 220 in communication on the outlet side with manual actuating valve 218. This first switched position is used for manually admitting compressed air to the spring-actuator part of brake cylinders 31, 41 for the purpose of canceling the parking brake function.

In the second switched position, manual actuating valve 218 establishes communication of pneumatic line 220 with a vent port 232 in communication with atmosphere. This second switched position is used for manually venting the spring-actuator part of brake cylinders 31, 41 for the purpose of initiating the parking brake function.

In the third switched position shown in FIG. 2, manual actuating valve 218 behaves neutrally—that is, it permits compressed air to flow through in both directions between pneumatic lines 219, 220.

Manual actuating valve 218 is intended to ensure manual initiation and cancellation of the parking brake function in the event of malfunctions in electric control of parking brake module 2. In malfunction-free normal operation of parking brake module 2, manual actuating valve 218 is therefore always adjusted to its third switched position. Manual actuating valve 218 represents an optimal expansion of parking brake module 2, but may not be required, depending on need and on applicable legal regulations.

A valve 221 is connected via pneumatic line 220 to valve 218. Valve 221 can be electromagnetically actuated via an electric line 222 connected to electronic control unit 208.

In its switched position shown in FIG. 2, valve 221 permits compressed air to flow through in both directions between pneumatic line 220 and a pneumatic line 223 on the outlet side. In the second switched position, valve 221 shuts off the flow of compressed air. To achieve a proportioned flow of compressed air, valve 221 can be activated with, for example, a clocked signal from electronic control unit 208.

According to an advantageous embodiment of the present invention, valve 221 is designed as a proportional valve. This means that proportional or at least quasi-proportional flow cross sections can be adjusted between the extreme values of passing position and shut-off position by activating the electromagnet with suitable electrical signals, such as, for example, a clocked signal. Proportional valve 221 is used for particularly accurate air supply and venting of a relay valve 224 connected downstream via pneumatic line 223. Relay valve 224 delivers an outlet pressure into a pneumatic line 225. This pressure corresponds to the pressure injected via pneumatic line 223 into a control chamber of relay valve 224. Thus, relay valve 224 obtains the compressed air necessary for this purpose from a pneumatic line in communication with compressed-air supply line 233.

Optionally, a pressure sensor 226 can be placed in communication with pneumatic line 225 disposed on the outlet side of relay valve 224. Pressure sensor 226 delivers an electrical signal corresponding to the pressure in pneumatic line 225 via an electric line to 227 electronic control unit 208, where the signal is evaluated as the actual pressure value.

For the purpose of a pipe-break safeguard, pneumatic line 225 is in communication via a shuttle valve 230 with pneumatic lines 203, 204 leading to brake cylinders 31, 41. Further, pneumatic line 225 is in communication with a 3/2-way valve 228. 3/2-way valve 228 is used as a trailer-checking valve. That is, a trailer-checking function can be activated by means of this valve. The trailer-checking function is a condition of the brake system in which braking of a trailer vehicle associated with the tractor vehicle is canceled if the parking brake function has been initiated, in order to give the driver of the tractor vehicle an opportunity to check whether the braking action of the parking brake of the tractor vehicle is sufficient alone to prevent the entire vehicle train from rolling away when the vehicle is parked. Such a check is necessary in particular for trailer vehicles in which the brakes of the trailer vehicle could be released, for example as a result of gradual pressure loss when the vehicle train is parked for an extended period. Also, in this case, it is desired that the vehicle does not roll, which is the responsibility of the parking brake of the tractor vehicle.

Trailer-checking valve 228 is constructed as an electromagnetically actuatable 3/2-way valve, which for actuation is connected via an electric line 229 to electronic control unit 208. In a first switched position illustrated in FIG. 2, trailer-checking valve 228 places pneumatic line 207 leading to trailer control valve 6 in communication with pneumatic line 225. In its second switched position, trailer-checking valve 228 places pneumatic line 207 in communication with compressed-air supply line 233 and, thus, with the compressed-air reservoir. In this second switched position, the trailer-checking function is activated. Under these conditions, the third pressure-control inlet of trailer control valve 6, which inlet is in communication with pneumatic line 207, is acted on with reservoir pressure, which by virtue of an inverting function of trailer control valve 6 causes release of the brakes of the trailer vehicle.

In conjunction with stabilizing valve 210, trailer-checking valve 228 performs a further function, namely resetting of stabilizing valve 210 from the safety position illustrated in FIG. 2 to the working position. For this purpose, during actuation of the trailer-checking function, trailer-checking valve 228 acts via pneumatic line 234 on one of the pneumatic control inlets of stabilizing valve 210. Relatively brief actuation of trailer-checking valve 228 by electronic control unit 208 is sufficient for the purpose of resetting stabilizing valve 210, and so the trailer-checking function is not necessarily fully activated. Thus, if the trailer vehicle is being braked, this action is not canceled as a result of the brief actuation.

In an advantageous embodiment of the present invention, parking brake module 2 comprises an electronics module plus a valve module, in which valves 210, 213, 218, 221, 224, 228 are structurally integrated. The valve module has a first compressed-air port, into which compressed-air supply line 233 opens, as well as a second compressed-air port into which pressure-delivery line 225 opens. In this case, shuttle valve 211 is fastened (e.g., screwed) directly onto the first compressed-air port, without further pneumatic lines, and shuttle valve 230 is fastened (e.g., screwed) directly onto the second compressed-air port. Shuttle valves 211, 230 are also provided optionally in connection with the pipe-break safeguard.

This has the advantage that no additional pipework or pneumatic lines are necessary for connection of shuttle valves 211, 230. Thus, assembly of parking brake module 2 in the vehicle becomes a relatively simple procedure that is not very time-consuming. A further advantage is that parking brake module 2 can be inserted simply, for example, by omitting one of the shuttle valves or by using different types of shuttle valves, and with little effort into other types of brake systems, especially brake systems in which dual layout of the pneumatic lines is not provided.

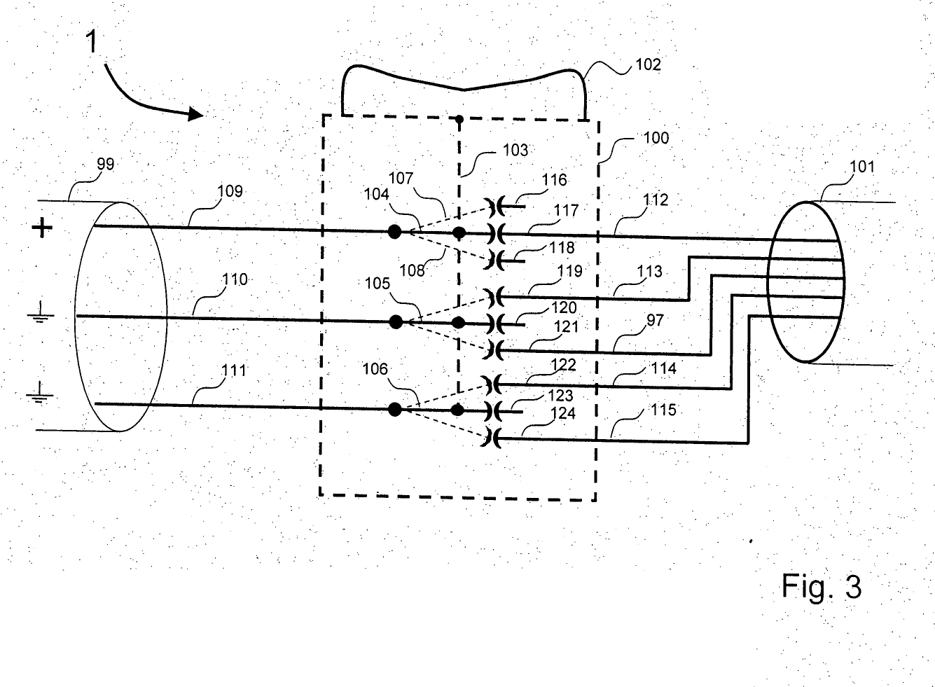

Referring now to FIG. 3, parking brake signal transmitter 1 is shown in detail. In an advantageous embodiment of the present invention, parking brake signal transmitter 1 is provided with a manually actuatable switch 100, which can be actuated by an operator via a self-resetting rocker switch 102 that can be actuated in two directions. By virtue of mechanical coupling via a coupling element 103, rocker switch 102, when manually actuated, causes actuation of three electrical switch elements 104, 105, 106. Switch elements 104, 105, 106 are preferably designed as changeover switches galvanically separated from one another, each having three switch positions. In FIG. 3, changeover switches 104, 105, 106 are shown in their respective middle positions, which are automatically established by the reset function in the absence of actuation of rocker switch 102. Taking changeover switch 104 as an example, the two other switch positions of this switch are shown by broken lines 107, 108. Changeover switches 104, 105, 106 are preferably ganged with one another. Thus, for example, if changeover switch 104 is actuated into position 107, changeover switches 105, 106 are also changed over (the same applies for the third switch position 108).

The switch position of changeover switch 104 shown by a solid line in FIG. 3 will be referred to hereinafter as the “neutral position.” Switch position 107 will be referred to hereinafter as the “parking brake position.” Third switch position 108 will be referred to hereinafter as the “trailer-checking position.”

Changeover switches 104, 105, 106 are electrically connected to electronic control unit 208 via lines 112, 113, 97, 114, 115, which, as individual lines, are part of multi-conductor line 101. As shown in FIG. 3, electrical switch contacts 116, 117, 118, 119, 120, 121, 122, 123, 124 of changeover switches 104, 105, 106, respectively, are not completely connected to electric lines. In changeover switch 104, for example, middle switch contact 117 (but not switch contacts 116, 118) is connected to electric line 112 when it makes contact in neutral position. In changeover switch 105, switch contacts 119, 121 (but not middle switch contact 120) are connected to electric lines 113, 97. In changeover switch 106, switch contacts 122, 124 (but not middle switch contact 123) are connected to electric lines 114, 115.

Switch 100 is supplied with electrical power by power-supply unit 98 via multi-conductor electric line 99. Multi-conductor electric line 99 contains an individual line 109 which connects the supply potential of power-supply unit 98 to changeover switch 104, as well as individual lines 110, 111 which connect the ground potential of power-supply unit 98 to changeover switches 105, 106. Via lines 112, 113, 114, 115, which act as output-signal lines, voltage signals from which electronic control unit 208 can determine the actuation position of switch 100 are supplied to electronic control unit 208. For the voltage signals received via line 112, electronic control unit 208 distinguishes between “battery voltage” and “open” states, and as to the voltage signals received via lines 113, 114, 115, 97, it distinguishes between “ground potential” and “open” states.

By the transmission of five voltage signals, which are generated by the three changeover switches 104, 105, 106 galvanically isolated from one another, error recognition is possible and, at least in the case of individual errors, so also is error correction of the received signals. Taking the case of cable break or short circuit as an example of an individual defect in one of electric lines 109, 110, 111, 112, 113, 97, 114, 115, therefore, electronic control unit 208 can recognize the defective nature of one of the five voltage signals and infer the actuation state of switch 100 by a majority decision of the remaining voltage signals.

For the defect-free condition, the voltage signals to be received by electronic control unit 208 are listed in the following table:

| Signal | | | Trailer-checking |
|---|---|---|---|
| line | Neutral position | Parking brake position | position |
| 112 | Battery voltage | Open | Open |
| 113 | Open | Ground potential | Open |
| 97 | Open | Open | Ground potential |
| 114 | Open | Ground potential | Open |
| 115 | Open | Open | Ground potential |

As is evident from the table, a change in switch position between neutral position and one of the two other switch positions in defect-free condition causes a change in three voltage signals. In any situation in which one individual error is present, two of the received five voltage signals still change. Electronic control unit 208 then decides which of the three voltage signal patterns listed in the table or which change pattern is most similar to the received voltage signals, thus recognizing the switch position from this information.

According to advantageous embodiments of the present invention, the brake system discussed above has the functions explained in greater detail hereinafter.

Electronic control unit 208 receives the signals from parking brake signal transmitter 1 and evaluates them. In doing so, electronic control unit 208 distinguishes between the actuation states of neutral position, parking brake position and trailer-control position.

During control of the parking brake function, electronic control unit 208 additionally distinguishes between two operating conditions of the vehicle, namely vehicle moving and vehicle stationary. To determine the respective prevailing operating condition, electronic control unit 208 receives the speed signals from modules 3, 5 via the vehicle bus and evaluates them. The vehicle is then considered to be stationary if the speed signals determined via wheel sensors 13, 23, 33, 43 indicate a speed of zero or at least close to zero. Otherwise the vehicle is considered to be a moving vehicle.

If actuation in the direction of the parking brake position is detected at parking brake signal transmitter 1, electronic control unit 208 first checks which actuation state of the parking brake function was present up to that time. That is, it checks whether the parking brake function was already activated or not activated. If the parking brake function was already activated, electronic control unit 208 then deactuates the parking brake function, but otherwise it actuates the parking brake function. Thus, it switches to the respective other actuation state. Thereupon, electronic control unit 208 checks whether the vehicle is in stationary or moving operating condition. In the case of actuation of the parking brake function for the moving vehicle, electronic control unit 208 sends a brake-demand signal via the data interface to modules 3, 5.

In an advantageous embodiment, the brake-demand signal contains an index value for vehicle deceleration. Modules 3, 5 receive the brake-demand signal and in response, by admitting compressed air to brake cylinders 11, 21, 31, 41, control the wheel brakes in accordance with the index value of vehicle deceleration such that the actual value of vehicle deceleration corresponds as closely as possible to the index value. Electronic control unit 208 sends this brake-demand signal as long as parking brake signal transmitter 1 is held in parking brake position and the vehicle is in moving condition. When parking brake signal transmitter 1 is no longer held in parking brake position while the vehicle is moving, electronic control unit 208 stops sending the brake-demand signal and deactuates the parking brake function. Thereupon, modules 3, 5 stop the brake engagement triggered by the brake-demand signal.

According to an advantageous embodiment of the present invention, electronic control unit 208 varies the index value for vehicle deceleration in accordance with a time function during the period in which parking brake signal transmitter 1 is held in parking brake position while the vehicle is moving. The time function contains a continuous increase of the index value from a minimum value to a maximum value.

When electronic control unit 208 recognizes, while the vehicle is moving and the parking brake function is activated, that the vehicle is coming to a standstill, electronic control unit 208 causes venting of the spring-actuator part of service/spring brake cylinders 31, 41, whereby the braking action of the spring actuators is initiated and thus the parking brake is applied. Moreover, electronic control unit 208 stops sending the brake-demand signal. Thereupon, modules 3, 5 stop the brake engagement triggered by the brake-demand signal.

According to another advantageous embodiment of the present invention, electronic control unit 208 does not stop the brake engagement triggered by the brake-demand signal suddenly in this case. Instead, it continues to send the brake-demand signal at first, but gradually reduces the braking force of the service brake required by the brake-demand signal. At the same time, electronic control unit 208 causes venting of the spring-actuator part of spring-actuated brake cylinders 31, 41, thus initiating the braking action of the spring actuator. This has the advantage that, as a result, an approximately constant brake-actuation force is always applied to the brakes and overloading of the brakes and brake mechanism by a brake-actuation force exaggerated by superposition of two influences on the brake-actuation force is largely avoided.

According to a further advantageous embodiment of the present invention, it can be additionally provided that the braking force of the service brake required by the brake-demand signal is reduced by precisely the proportion in which the braking force applied by the spring actuator increases. Thereby, the transition between the service brake and the spring-actuator brake function is made even smoother. This has the advantage that the braking operation becomes more comfortable for the vehicle driver and can be better anticipated by other traffic participants.

When the vehicle is stationary, the time during which parking brake signal transmitter 1 is actuated in parking brake position is substantially immaterial. In this operating condition of the vehicle, brief actuation by as little as tapping already causes actuation or deactuation of the parking brake function.

In the case of actuation of the parking brake function while the vehicle is stationary, electronic control unit 208 immediately causes venting of spring-actuated brake cylinders 31, 41, whereby the braking action of the spring actuators is initiated and thus the parking brake is applied.

In the case of deactuation of the parking brake function while the vehicle is stationary, electronic control unit 208 immediately causes admission of air to the spring-actuator part of spring-actuated brake cylinders 31, 41, whereby the braking action of the spring actuators is canceled and thus the parking brake is released.

According to another advantageous embodiment of the present invention, deactuation of the parking brake function is permitted only if the brake pedal is actuated simultaneously. For this purpose, electronic control unit 208 receives, via the data interface, from front-axle brake-control module 3, a signal indicating actuation of brake pedal 4, and it executes the actions associated with deactuation of the parking brake function only if brake pedal 4 is actuated.

Besides actuation of the parking brake function by means of parking brake signal transmitter 1, it is additionally provided according to an advantageous embodiment of the present invention that electronic control unit 208, upon receiving an actuation signal via the data interface, that is, via data-interface port 62, actuates the parking brake function. This has the advantage that the parking brake function can also be actuated by other systems provided in the vehicle, if such systems are suitable for exchange of information with parking brake module 2 via the data bus. This feature can be implemented for safety reasons, for example, such as an anti-theft system or in the case of vehicles having a crane function.

Via pneumatic line 207, the brakes of a trailer vehicle that may be coupled will also be actuated in the manner described above. This also includes actuation, while the vehicle is moving, of the brakes in the manner dictated by the brake-demand signals sent by electronic control unit 208. In this case, an electrical signal corresponding to the brake-demand signal will be delivered by module 3 to trailer control valve 6.

During actuation of parking brake signal transmitter 1 into trailer-checking position, electronic control unit 208 causes actuation of trailer-checking valve 228 to the second switched position via electric line 229 while the vehicle is stationary and the parking brake function is already actuated. Thereby, reservoir pressure from compressed-air supply line 233 is admitted via pneumatic line 207 to the pneumatic control port of trailer control valve 6 in communication with line 207. Admission to or actuation of trailer-checking valve 228 takes place as long as parking brake signal transmitter 1 is held in trailer-checking position. The admission of pressure to trailer control valve 6 causes release of the brakes of the trailer vehicle by virtue of the inversion function. At the same time, the parking brake of the tractor vehicle remains applied. As soon as parking brake signal transmitter 1 returns to neutral position, electronic control unit 208 switches trailer-checking valve 228 back to the first switched position illustrated in FIG. 2. Thus, the control port of trailer valve 6 in communication with pneumatic line 207 is vented and the brakes of the trailer vehicle are reset to the actuation state existing before actuation of parking brake signal transmitter 1. In this case electronic control unit 208 ignores any actuation of parking brake signal transmitter 1 that may take place to trailer-checking position while the vehicle is moving.

If the brake system is equipped with a hill-brake function, then the user has the capability of activating or deactivating the hill-brake function via hill-brake signal transmitter 60. A hill-brake function, which can be implemented in modules 3, 5, for example, by means of software, can be configured such that monitoring as to whether the vehicle is coming to a standstill takes place after the hill-brake function has been activated while the vehicle is moving. If it is recognized that the vehicle is at a standstill in response to brake actuation by the driver, the respective brake pressures present in all brake cylinders as well as in the trailer brake system are then held automatically at the currently existing level by actuation of valves 12, 22 as well as of the valves provided in rear-axle brake-control module 5, without the need for the driver to continue actuating brake pedal 4. Thus, the vehicle can be held at a standstill on an inclined roadway even after brake pedal 4 has been released. As soon as it is recognized that the driver intends to drive the vehicle, the wheel brakes as well as the trailer brake system are automatically released.

In the case of the hill-brake function described above, it may occur that, in the event of a defect in the brake system, especially an electrical defect in electrical or electronic components, such as modules 3, 5, the brake pressure in individual or all brake cylinders or in the trailer brake system cannot be maintained. An example of a possible defect is failure of the voltage supply. In such a case, the vehicle would be completely unbraked.

According to another advantageous embodiment of the present invention, electronic control unit 208 contains a function for recognizing actuation of the hill-brake function, for example by evaluation of the data received via the data interface. If electronic control unit 208 additionally perceives the occurrence of a defect in the brake system while the hill-brake function is activated, electronic control unit 208 actuates the parking brake function. Thus, vehicle rolling can be safely prevented even if the voltage supply has been turned off by the driver with the ignition switch or if one of the aforesaid defects has developed. A further advantage is that sustained actuation of at least one of the vehicle pedals for the purpose of maintaining the hill-brake function, as is necessary in known solutions, is not required here. Thereby, the vehicle driver is freed from unnecessary burdens.

According to another advantageous embodiment of the present invention, electronic control unit 208 always actuates the parking brake function when it recognizes actuation of the hill-brake function, or in other words even if no defect exists in the brake system.

Upon deactuation of the hill-brake function by actuation of hill-brake signal transmitter 60, or upon recognition that the vehicle is driving away, electronic control unit 208 simultaneously deactuates the parking brake function.

According to a further advantageous embodiment of the present invention, electronic control unit 208 does not activate the parking brake function all at once upon recognition of actuation of the hill-brake function. Rather, it switches proportional valve 221 to shut-off position and bistable valve 213 into venting position (see FIG. 2). Thereby, nothing is changed at first in the hill-brake function and its effects, provided no defect is present in the brake system. When a defect develops, however, as can also be recognized by electronic control unit 208, for example, by receiving a defect-information signal from one of modules 3, 5 via the data interface, electronic control unit 208 switches proportional valve 221 to passing position. Thereby, spring-actuated brake cylinders 31, 41 are vented, allowing braking action of the spring actuator. In addition, the brake system of the trailer vehicle is fully actuated via pneumatic line 207.

When the defect is of such nature that the voltage supply for parking brake module 2, and possibly other parts of the brake system, has failed, then proportional valve 221 is also reset automatically by spring force to passing position. In any case, bistable valve 213 has the property that it maintains its switched position in the absence of electrical actuation, so that even in this case spring-actuated brake cylinders 31, 41 as well as pneumatic line 207 are vented, with the result that the braking action of the spring actuator occurs and the brake system of the trailer vehicle is actuated.

This aspect of the invention has the advantage that the pressure present in any case in the brake cylinders continues to be used for braking at first. Thus, no additional compressed air is consumed. Only in the case of a defect does a changeover involving air consumption take place to the braking action of the spring actuator.

According to another advantageous embodiment of the present invention, electronic control unit 208 includes a mode for adjustable actuation of the parking brake, or in other words for adjustment of a particular braking force to be applied by the parking brake. For this purpose, electronic control unit 208, on the basis of a brake-demand signal that contains, for example, a brake-pressure index value, controls valves 213, 221 such that the brake pressure building in pneumatic line 225 corresponds at least approximately to the brake-pressure index value. For this purpose, electronic control unit 208 checks, by means of pressure sensor 226, the pressure building in pneumatic line 225 and, if necessary, corrects the pressure by actuating valves 213, 221. As an alternative to the brake-pressure index value, the brake-demand signal can also contain, for example, a vehicle index deceleration. In such case, electronic control unit 208 regulates the pressure to be established in pneumatic line 225 on the basis of the actual deceleration, which electronic control unit 208 calculates on the basis of speed signals received via the data interface from wheel sensors 13, 23, 33, 43.

Electronic control unit 208 can receive the brake-demand signal from one of modules 3, 5 via, for example, the data interface. This mode is also referred to as “automatic auxiliary braking.” Automatic auxiliary braking is used by one of modules 3, 5, in that it sends defined brake-demand signals to electronic control unit 208 via the data bus if at least one wheel brake equipped with a spring-actuated brake cylinder fails in the service-brake loop. In this case, a braking action can still be achieved via the spring-actuator brake function of such brake cylinders.

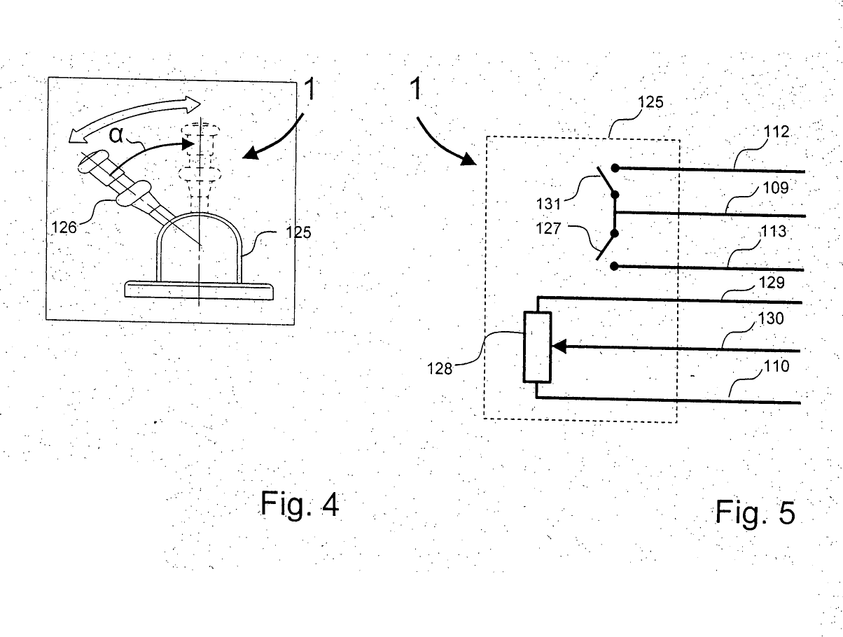

According to an advantageous improvement of the invention, parking brake signal transmitter 1 can also be designed as a proportional-brake signal transmitter, which delivers proportional signals for adjustment of the braking force to be applied by the parking brake. Such a proportional-brake signal transmitter will be discussed in greater detail hereinafter with reference to FIGS. 4 through 6.

Proportional-brake signal transmitter 1 depicted in FIG. 4 is provided with a housing 125 as well as with an actuating lever 126 that can be swiveled manually by the vehicle operator. This lever is mounted pivotally in housing 125 and can be actuated against the force of a spring. The measure for actuation of actuating lever 126 relative to the position illustrated by solid lines in FIG. 4 is referred to hereinafter as the “actuating angle α.” In the absence of manual actuation, actuating lever 126, which can be actuated against spring force, is restored to the position shown in FIG. 4 or is held in this position by virtue of the spring force.

In an advantageous embodiment of the invention, actuating lever 126 is latched in a particular position, such as the position shown by broken lines in FIG. 4, but can be actuated beyond that latched position to an end position.

Actuation of actuating lever 126 into the latched position can be used as a criterion for actuation of the parking brake function with full spring-actuator braking action. The latched position corresponds to the parking brake position of parking brake signal transmitter 1 described above. Actuation beyond the latched position can be the criterion for actuation of the trailer-checking function. This actuation corresponds to the trailer-checking position of parking brake signal transmitter 1 described above. If actuating lever 126 is released from this trailer-checking position, actuating lever 126 is returned to latched position by virtue of the spring force.

Referring now to FIG. 5, there is shown the electrical layout of electrical signal transmitters disposed in housing 125. Housing 125 contains a first switch element 131, a second switch element 127 and a proportional element 128. As an example, proportional element 128 can be designed as a potentiometer and switch elements 131, 127 as momentary-contact switches. Actuation of proportional element 128 takes place directly by swiveling actuating lever 126. Switch elements 131, 127 cannot be manually actuated separately by an operator, but are also actuated by the swiveling of actuating lever 126. Their actuation takes place via operating cams, which are moved during swiveling of actuating lever 126.

Switch elements 131, 127 are supplied with battery voltage via line 109. Switch elements 131, 127 deliver switching signals S1, S2 via lines 112, 113 to electronic control unit 208. Electronic control element 208 supplies proportional element 128 with ground potential via line 110 and with a predetermined voltage potential via a line 129. Proportional element 128 delivers a proportional signal P, such as a voltage signal, corresponding to actuating angle a to electronic control unit 208 via a line 130.

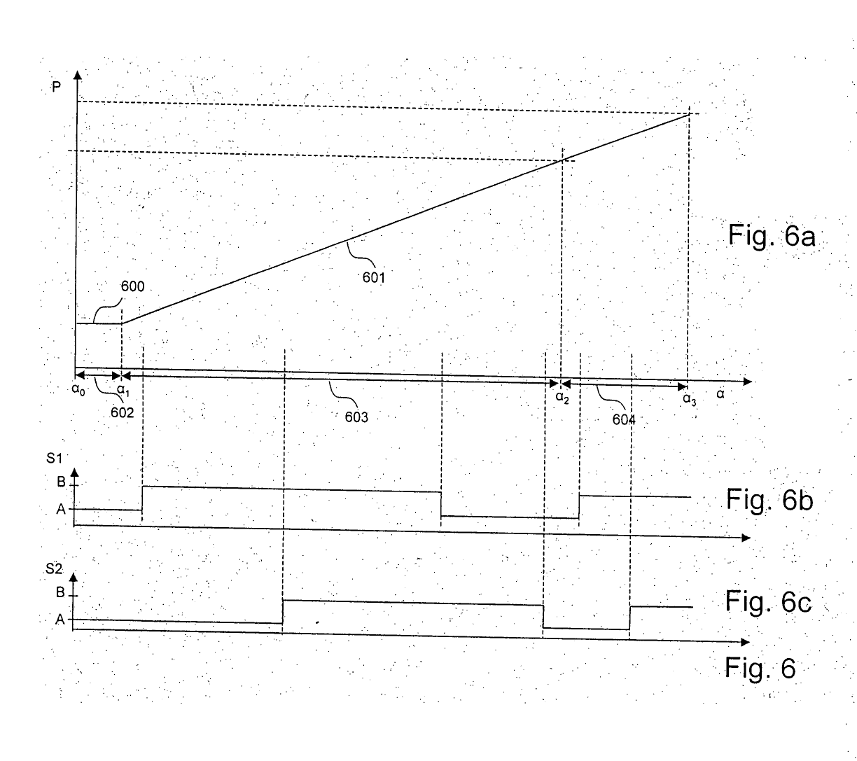

FIGS. 6a-6c depict graphical plots of the shapes of characteristics of the proportional signal P and of the switching signals S1, S2 versus actuating angle α signal characteristics of the proportional brake-signal transmitter. With regard to actuating angle α, there are defined three regions 602, 603, 604 which are associated with the actuation positions of parking brake signal transmitter 1, namely, the neutral position, the parking brake position and the trailer-checking position. Thus, region 602 between actuating-angle values α₀, α₁, is associated with the neutral position, proportional region 603 between actuating-angle values α₁, α₂ is associated with the parking brake position, and region 604 between actuating-angle values α₂, α₃ is associated with the trailer-checking position. At the upper end α₂ of the parking brake region, actuating lever 126 is in latched position.

FIG. 6a, which shows the shape of the characteristic of proportional signal P of proportional element 128, shows a characteristic composed of two straight segments 600, 601, with a proportional relationship between actuating angle a and proportional signal P in proportional region 603.

FIG. 6b shows the shape of the characteristic of switching signal S1 of switch element 131. FIG. 6c shows the variation of switching signal S2 of switch element 127. In this case, a signal condition “A” represents an open operating state and a signal condition “B” represents a closed operating state of the respective switch element 131, 127. Switch elements 131, 127 are used to generate redundant signals in the case of a defect or malfunction in proportional element 128. The shapes of the characteristics of switching signals S1, S2 are chosen in such a way relative to regions 602, 603, 604 that, even in the event of a defect in proportional element 128, at least a rough determination of the position of actuating angle α is possible by evaluation of switching signals S1, S2.

Electronic control unit 208 receives proportional signal P and first determines, by classification of this signal into one of the regions 602, 603, 604, whether the neutral position, the parking brake position or the trailer-checking position has been selected by means of actuating lever 126. In the case of the parking brake region, electronic control unit 208 calculates a brake-demand signal from proportional signal P or directly calculates a pressure value to be established in pneumatic line 225. If the vehicle is moving, electronic control unit 208 transmits the brake-demand signal to modules 3, 5, which actuate the respective brakes associated with them in the already explained manner as dictated by the brake-demand signal. Also if the vehicle is moving, electronic control unit 208 adjusts the pressure value to be established in pneumatic line 225 by actuating valves 213, 221.

If the vehicle is stationary and actuating lever 126 has been actuated into the latched position, electronic control unit 208 actuates the parking brake function with the maximum possible braking action.

Further, electronic control unit 208 sends the calculated brake-demand signal via the data interface to, for example, modules 3, 5. In an embodiment of the present invention, modules 3, 5 have a function by which, in the event of a defect in the brake-signal transmitter connected to brake pedal 4, they use this brake-demand signal that can be received from electronic control unit 208 for braking the vehicle, or in other words for determining and establishing a braking force. Thereby, the vehicle driver has an opportunity to brake the vehicle gradually even in the event of a defect in the brake-signal transmitter, whereby the operating safety of the brake system and of the vehicle is increased.

According to another advantageous embodiment of the present invention, electronic control unit 208 is equipped with an electrical energy accumulator 236, which is used to maintain the parking brake function at least partly in the event of failure or malfunction of the on-board voltage supply. Via voltage-supply port 202, electrical energy accumulator 236 is kept permanently in fully charged condition during malfunction-free operation of the on-board voltage supply. In the event of failure or malfunction of the on-board voltage supply, electronic control unit 208 is isolated at least partly from the voltage supply, in order to save power. In this operating condition, parking brake signal transmitter 1 controls bistable valve 213 directly via an electrical changeover. Under these conditions, the parking brake function can still be activated and deactivated by the operator, but the further functions that can be executed by electronic control unit 208 in the malfunction-free condition, such as gradual actuation of the service brake while the vehicle is moving, the trailer-checking function or the stabilizing function explained in greater detail hereinafter, are unavailable. In an advantageous embodiment of the present invention, electrical energy accumulator 236 is designed in the form of high-capacitance capacitors structurally integrated in electronic control unit 208.

According to a further advantageous embodiment of the present invention, electronic control unit 208 is connected to an electrically actuatable display element 237. Display element 237 is used for optical display of the actuation state of the parking brake, and in this connection is preferably disposed in the field of view of the vehicle operator. Display element 237 is suitable for displaying two conditions, such as parking brake function activated and deactivated. For this purpose, display element 237 is provided with a bistable switch function, which retains the last display condition to be established even after the supply voltage has been turned off. Preferably, display element 237 can be actuated by relatively short electrical pulses from electronic control unit 208.

According to another advantageous embodiment of the present invention, a stabilizing function having the form of a program subroutine in electronic control unit 208 is provided instead of stabilizing valve 210. If the vehicle is stationary, this subroutine automatically actuates the parking brake function when the reservoir pressure, or in other words the pressure in second compressed-air reservoir 52, which is responsible for brake cylinders 31, 41 having spring-actuator brake function, falls below the release pressure of the spring actuator brake function, meaning that the spring-actuator brake function would become inactive. Thereby, it is possible to dispense with stabilizing valve 210, thus leading to more favorable manufacturing costs for parking brake module 2.

As part of the stabilizing function, electronic control unit 208 monitors the reservoir pressure as well as the operating condition of the vehicle, or in other words whether the vehicle is in stationary or moving condition. The data signals necessary for this purpose are received by electronic control unit 208 from the vehicle bus via the data interface. If electronic control unit 208 in this situation detects, while the vehicle is stationary, that the reservoir pressure is lower than the minimum pressure value set for initiation of the spring-actuator brake function, but the parking brake function has not been activated by that time, as can be recognized from the fact, for example, that bistable valve 213 is in vent position, then electronic control device 208 automatically actuates the parking brake function. Thereby, the vehicle is maintained at a standstill. This automatic actuation of the parking brake function can be deactivated once again by a vehicle operator, in that parking brake signal transmitter 1 can be actuated into parking brake position.

In another embodiment of the present invention, electronic control unit 208 ignores actuation of parking brake signal transmitter 1 for deactuation of the parking brake function at least until it is detected that the reservoir pressure is once again higher than the minimum pressure value.

According to a further advantageous embodiment of the present invention, actuation of the trailer brake system via trailer control valve 6 takes place exclusively via modules 3, 5, or in other words without direct influence by parking brake module 2. In this case, there is no need for trailer-checking valve 228 or the associated pneumatic lines and the control inlet on trailer control valve 6. In this configuration, electronic control unit 208 sends, via the data interface, to modules 3, 5, the actuation intent for the parking brake function as dictated by actuation of parking brake signal transmitter 1. Via trailer control valve 6, modules 3, 5 then actuate the trailer brake system in accordance with the actuation principles discussed herein, especially partial braking while the vehicle is moving and full braking only when the vehicle is stationary. During actuation of parking brake signal transmitter 1 into the trailer-checking position, electronic control unit 208 sends a corresponding signal via the data interface to modules 3, 5. Via trailer control valve 6, modules 3, 5 then release the brakes of the trailer vehicle for as long as electronic control unit 208 is sending the signal to this effect.

According to another advantageous embodiment of the invention, electronic control unit 208 is provided with a mode of operation in which electronic control unit 208 always actuates the parking brake function automatically, or in other words without actuation of parking brake signal transmitter 1, if the engine is turned off while the vehicle is stationary, for example, when the ignition has been turned off. For certain types of vehicles, this mode of operation can be preset, for example by the vehicle manufacturer, in which case, in general, it can no longer be deactivated by a user. If this mode of operation has been selected, it may nevertheless be necessary in individual cases, for example in order to tow a defective vehicle, to override the automatic actuation of the parking brake function. For this purpose, electronic control unit 208 checks, before automatically activating the parking brake function, whether parking brake signal transmitter 1 has been moved manually to trailer-checking position and whether the engine is held in this position during parked condition. If such a case is recognized, electronic control unit 208 does not automatically activate the parking brake function.

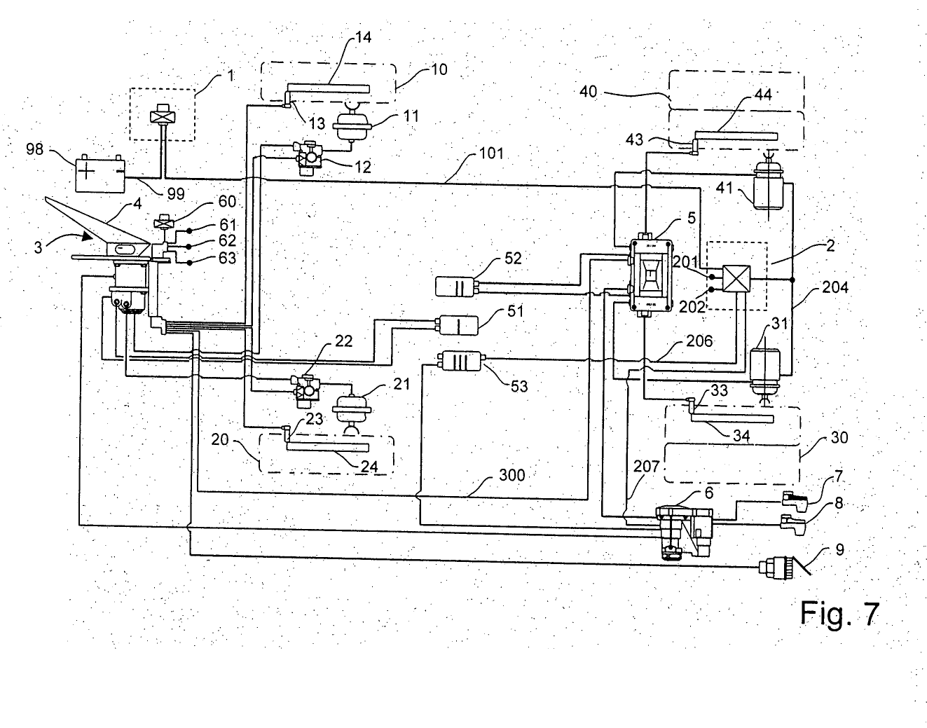

FIG. 7 depicts a further advantageous embodiment of an air-brake system according to the present invention. The air-brake system shown in FIG. 7 corresponds largely to the air-brake system according to FIG. 1, with the difference that no pipe-brake safeguard is provided in the air-brake system of FIG. 7. Thus, shuttle valves 35, 45 are not needed, nor are shuttle valves 211, 230 screwed into parking brake module 2 or the associated dual pneumatic lines. In this case, parking brake module 2 is supplied with compressed air from compressed-air reservoir 53. The configuration of the air-brake system according to FIG. 7 has the advantage that fewer pneumatic lines are installed and there is no need for the shuttle valves.

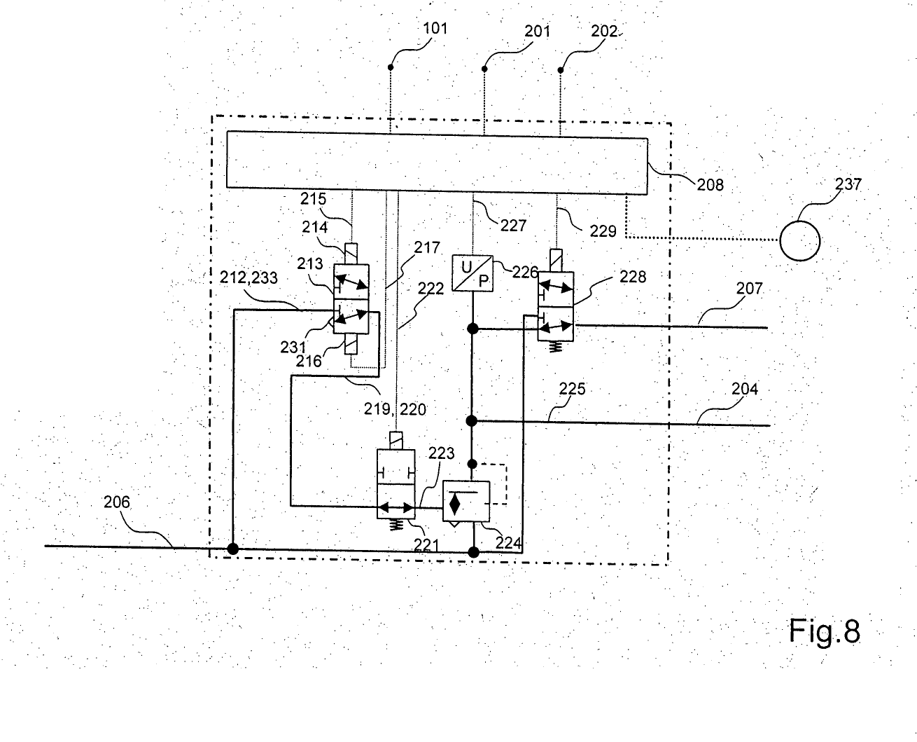

FIG. 8 depicts a further advantageous embodiment of parking brake module 2 in accordance with the present invention. Parking brake module 2 depicted in FIG. 8 corresponds largely to parking brake module 2 depicted in FIG. 2, with the difference that no pipe-break safeguard is provided in the parking brake module according to FIG. 8, and also that optional stabilizing valve 210 and optional manual actuating valve 218 are not included. Otherwise, the principle of action corresponds to parking brake module 2 according to FIG. 2. The configuration of parking brake module 2 according to FIG. 8 has the advantage that the cost associated with optional valves 210, 218 can be avoided. In conjunction with the stabilizing function discussed above provided as a program subroutine in electronic control unit 208, this advantage is achieved without compromising safety.

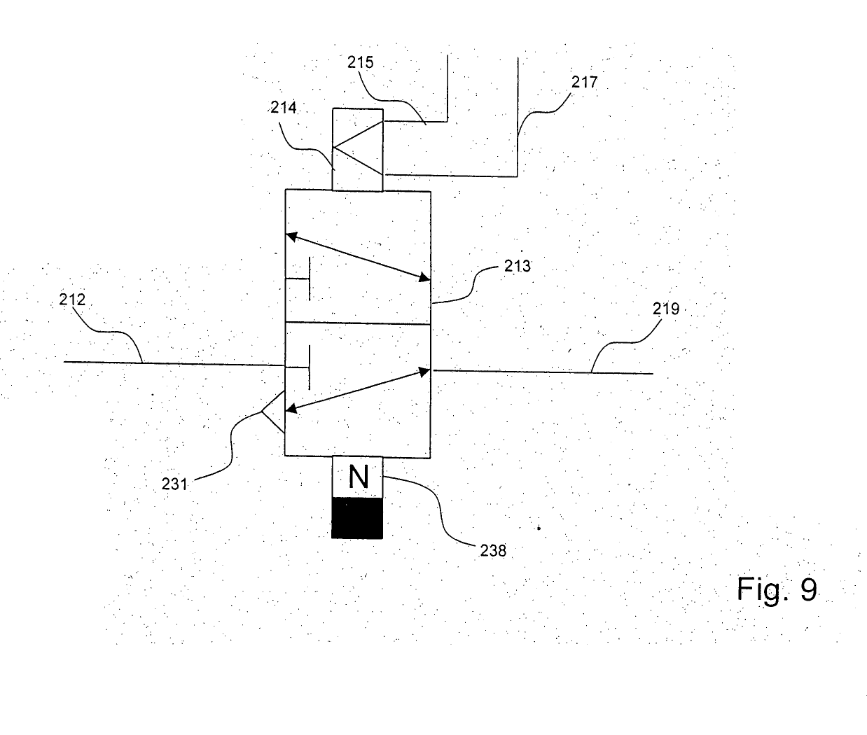

FIG. 9 shows a further advantageous embodiment of bistable valve 213 in accordance with the present invention. In contrast to the bistable valve illustrated in FIGS. 2 and 8, bistable valve 213 depicted in FIG. 9 has only a single electromagnet 214 for actuation as well as one permanent magnet 238. In this case, electromagnet 214 is used to change over bistable valve 213 into both switched positions, namely vent position and pressure-supply position. Changeover takes place by reversal of polarity of the electrical voltage supplied to electromagnet 214 by electronic control unit 208 via lines 215, 217. Permanent magnet 238 is used to maintain bistable valve 213 in the desired switched position without the need for electrical voltage to be supplied continuously to electromagnet 214. Changeover of bistable valve 213 can therefore be initiated by electronic control unit 208 by means of a voltage pulse. Thereby, bistable valve 213 can be operated with very low energy demand.

Accordingly, the present invention provides new embodiments of a fluid-pressure brake system in which there can be integrated, with little complexity and in compliance with applicable safety regulations for brake systems, a parking brake function that can be actuated via an electrical signal transmitter.

It will thus be seen that the objects set forth above, among those made apparent from the preceding description, are efficiently attained, and since certain changes may be made in carrying out the above method and in the constructions set forth without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

1. A fluid-pressure brake system for a vehicle, comprising a brake pedal, wheel brakes, at least one wheel brake actuator constructed and arranged to admit pressurized fluid, a parking brake signal transmitter, at least one of said wheel brakes being actuatable in response to manual actuation of said parking brake signal transmitter and without actuation of said brake pedal, a parking brake module, said parking brake module including an electronic control unit and at least one valve device electrically actuatable by said electronic control unit, said electronic control unit adapted to actuate at least one of said wheel brakes by controlled admission of pressurized fluid to said actuator by means of said at least one valve device in response to an electrical actuating signal transmitted from said parking brake signal transmitter and without actuation of said brake pedal.

2. The brake system according to claim 1, wherein said actuator is designed as a spring-actuated brake cylinder.

3. The brake system according to claim 1, wherein admission of pressurized fluid to said actuator is decreased during reception by said electronic control unit of said electrical actuating signal.

4. The brake system according to claim 1, further comprising an electrical energy accumulator constructed and arranged to maintain at least partial actuation of at least one of said wheel brakes in response to actuation of said parking brake signal transmitter and without actuation of said brake pedal when the on-board voltage supply of said vehicle at least one of fails and malfunctions.

5. The brake system according to claim 1, wherein said at least one electrically actuatable valve device includes a bistable valve having a bistable switching function including first and second operating states, said first operating state characterized by pressurized fluid being fed to said actuator and said second operating state being characterized by pressurized fluid being removed from said actuator.

6. The brake system according to claim 5, wherein one of said at least one electrically actuatable valve device is disposed in a fluid path between said bistable valve and said actuator, said one of said at least one electrically actuatable valve device adapted to shut off fluid flow between said bistable valve and said actuator.

7. The brake system according to claim 6, further comprising a relay valve disposed between said one of said at least one electrically actuatable valve device and said actuator.

8. The brake system according to claim 5, wherein said bistable valve is designed as a 3/2-way valve actuatable by two electromagnets.

9. The brake system according to claim 1, further comprising a pressurized fluid reservoir and at least one manual actuating valve disposed between said fluid reservoir and said actuator, said manual actuating valve constructed and arranged to permit pressurized fluid to be at least one of manually fed to and removed from said actuator.

10. The brake system according to claim 9, wherein said manual actuating valve is designed as a 4/3-way valve.

11. The brake system according to claim 8, further comprising a stabilizing valve disposed between said fluid reservoir and said actuator.

12. The brake system according to claim 1, wherein said parking brake module has inlet and outlet sides, said parking brake including at least one shuttle valve on at least one of said inlet and outlet sides, said at least one shuttle valve constructed and arranged to permit integration into a dual loop brake system arrangement.

13. The brake system according to claim 12, wherein said at least one shuttle valve is fastened directly to fluid ports of said parking brake module.

14. The brake system according to claim 1, further comprising a trailer-checking valve for releasing the brakes of a trailer vehicle.

15. The brake system according to claim 1, further comprising brake cylinders including spring actuator parts adapted to effect a spring-actuated brake function, a pressurized fluid reservoir and means for automatically actuating at least one of said wheel brakes in response to actuation of said parking brake signal transmitter and without actuation of said brake pedal when said vehicle is stationary and pressure in said fluid reservoir drops below a pressure causing cancellation of said spring-actuated brake function.

16. The brake system according to claim 1, wherein said parking brake signal transmitter has a neutral position, a parking brake position and a trailer-checking position.

17. The brake system according to claim 16, wherein said electronic control unit is adapted to increment a braking-force signal during a period of actuation of said parking brake signal transmitter into said parking brake position and to adjust braking force based on said braking-force signal.

18. The brake system according to claim 16, wherein brief actuation of said parking brake signal transmitter into said parking brake position effects maximum braking force when said parking brake function has not been activated and said vehicle is stationary.

19. The brake system according to claim 1, wherein said electrical parking brake signal transmitter includes a proportional element for presetting a braking-force signal and said electronic control unit adjusts braking force based on said braking-force signal.

20. The brake system according to claim 1, further comprising a hill-brake signal transmitter for effecting a hill-brake function, and wherein when said hill-brake function is actuated, at least one of said wheel brakes is automatically actuated.

21. The brake system according to claim 1, further comprising a vehicle data-bus and wherein at least one of said parking brake module and said electronic control unit includes a port for a data interface, said port being adapted for connection to said vehicle data-bus, and wherein said electronic control unit actuates at least one of said wheel brakes when an actuation signal is received via said data interface and without actuation of said brake pedal.

22. The brake system according to claim 1, wherein deactuation of at least one of said wheel brakes actuated in response to said parking brake signal transmitter without actuation of said brake pedal is permitted only when said brake pedal is simultaneously actuated.
